(19) United States
(12) Patent Application Publication
(10) Pub. No.: US 2026/0359206 A1
(43) Pub. Date: Nov. 12, 2026

(54) FACILITATING VIRTUAL ASSISTANT TRAINING

(71) Applicant: International Business Machines Corporation, Armonk, NY (US)

(72) Inventors: Lorena Braghini Miranda, Sao Paulo (BR); Lucas Henrique Lima Soares, Sao Paulo (BR); Giovani Kisz, Sao Paulo (BR); Alan Braz, Campinas (BR)

(21) Appl. No.: 19/200,013

(22) Filed: May 6, 2025

(51) Int. Cl. G06F 11/3668; G06F 11/3604

(52) U.S. Cl. CPC G06F 11/3696; G06F 11/3616; G06F 11/3688

(57) ABSTRACT

Improving a given virtual assistant's training includes obtaining a dataset used to train the given virtual assistant. The dataset is partitioned into a plurality of partitioned datasets. A plurality of new virtual assistants are created corresponding to the number of partitioned datasets. Each of the new virtual assistants is trained using at least one of the partitioned datasets with one or more randomly selected samples being removed, where different one or more of the partitioned datasets are used to train each of the new virtual assistants. Each of the new virtual assistants are tested and results are captured. The results are visualized and presented via a graphical user interface.

### BACKGROUND

The present application relates generally to computers and computer applications, machine learning, and more particularly to improving the training of a virtual assistant or virtual agent.

### BRIEF SUMMARY

The summary of the disclosure is given to aid understanding of a computer system and method of facilitating a training of an artificial intelligent agent such as a virtual assistant, and not with an intent to limit the disclosure or the invention. It should be understood that various aspects and features of the disclosure may advantageously be used separately in some instances, or in combination with other aspects and features of the disclosure in other instances. Accordingly, variations and modifications may be made to the computer system and/or their method of operation to achieve different effects.

A computer-implemented method in some embodiments includes obtaining a dataset used for training a given virtual assistant. The computer-implemented method also includes partitioning the dataset into a plurality of partitioned datasets. The computer-implemented method also includes creating a plurality of untrained virtual assistants equal to a number of the plurality of partitioned datasets. The computer-implemented method also includes, for each created untrained virtual assistant of the created untrained virtual assistants, training the created untrained virtual assistant with at least one of the plurality of partitioned datasets having at least one random data sample removed, and testing the trained virtual assistant, capturing expected intent and predicted intent of the trained virtual assistant. The computer-implemented method also includes generating a plurality of metrics for the trained virtual assistants based on the testing. The computer-implemented method also includes presenting via a graphical user interface results of the testing.

A computer system in some embodiments includes a processor set. The system also includes a set of one or more computer-readable storage media. The system also includes program instructions, collectively stored in the set of one or more computer-readable storage media, for causing the processor set to perform computer operations the computer operations includes obtaining a dataset used for training a given virtual assistant; partitioning the dataset into a plurality of partitioned datasets. The computer operations also include creating a plurality of untrained virtual assistants equal to a number of the plurality of partitioned datasets. The computer operations also include, for each created untrained virtual assistant of the created untrained virtual assistants, training the created untrained virtual assistant with at least one of the plurality of partitioned datasets having at least one random data sample removed, and testing the trained virtual assistant, capturing expected intent and predicted intent of the trained virtual assistant. The computer operations also include generating a plurality of metrics for the trained virtual assistants based on the testing. The computer operations also include presenting via a graphical user interface results of the testing.

In some embodiments, a computer program product comprising a set of one or more computer-readable storage media, and program instructions, collectively stored in the set of one or more storage media, for causing a processor set to perform computer operations that perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 shows an example of a computing environment, which can implement improved training of a virtual assistant in some embodiments.

FIG. 2 is a diagram illustrating a process or method that evaluates how a trained virtual assistance performs in some embodiments.

FIG. 3 shows components of a system in some embodiments.

FIG. 4 shows an overall architecture of a development cycle for improving virtual assistant training in some embodiments.

FIG. 5 is a flow diagram illustrating a method that improves virtual assistant training in some embodiments.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as virtual assistant training code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

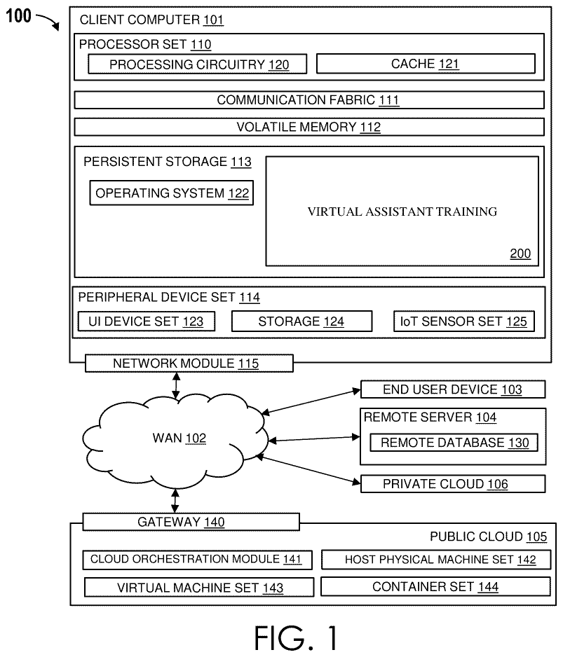

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Systems, methods, and/or techniques are provided that help improve the training of a virtual assistant. A virtual assistant is an artificial intelligence (AI) agent that can converse with a human user (or another user) via a user device and provide an assistance (e.g., answering questions, following a conversation stream, etc.) to that user regarding a task. A virtual assistant uses machine learning and natural language processing to analyze the user's input and determine the most likely action or task the user wants to perform. A virtual assistant is trained on a dataset and learns to predict intents based on the training process.

A technique disclosed herein in some embodiments teach a virtual assistant the intents about which the virtual assistant should be able to have a conversation, and improve that virtual assistant's capability to hold a conversation about that intent. An intent or intention refers to a goal or a purpose of an interaction. For example, a user may engage in a conversation with a virtual assistant with an intent or intention, a goal or purpose the user desires to achieve. An intent or intention can be classified into a subject or topic. A virtual assistant is trained using phrases that are classified as belonging to an intent or intention.

A performance of a deployed virtual assistant can be evaluated usually by analyzing the log data of the conversations the deployed virtual assistant had while servicing users and then determining whether the stream of conversation carried through by the virtual assistant appropriately focused on the intent. However, while such methodologies may help to identify possible deficiencies and improve the virtual assistant's future performance, it remains that the users are still exposed to those possible deficiencies of the initially deployed version of the virtual assistant.

In some embodiments, a technique disclosed herein tests or checks that a trained virtual assistant is well trained, for example, would perform its functions well, before the trained virtual assistant is actually deployed in the real world, allowing for pre-emptively correcting or improving aspects of the virtual assistant before the virtual assistant is deployed and used in the real world.

In some embodiments, the technique helps a curator of a virtual assistant identify potential flaws in the virtual assistant's training by analyzing the example sentences in the training set. The technique includes generating metrics that allow the curator to identify which intentions have few examples in the training, and/or which intentions have similar training and can be confused, for example. For example, the technique includes generating metrics about the training data that allows for greater assertiveness in identifying problems in the virtual assistant training. The technique also accelerates the virtual assistant curation process by analyzing the training quality of phrases used as intentions.

In some embodiments, the technique trains a virtual assistant by a specific implementation of cross-validation and provides an understanding of an AI engine that empowers the virtual assistant trained on the AI engine about the intentions.

In some embodiments, the technique analyzes the training data of a virtual assistant, generates metrics that allow assertive curation of the virtual assistant's performance, thus allowing for evaluating of the training of a virtual assistant. The metrics allows for a more accurate curation of the virtual assistant training. The performance of a virtual assistant as a whole, can be evaluated based on all training data of the virtual assistant. The technique can apply to a virtual assistant that is already trained and can improve further training.

In some embodiments, the systems, methods and/or techniques can provide a tool for curating virtual assistants. The tool suggests the analysis of the training quality of the subjects served by the virtual assistant, generating metrics that facilitate the curation and improvement of the virtual assistant training. The tool can provide a focus on a solid understanding of the limitations and improvement points of the analyzed virtual assistant.

When working with a large volume of data, such as the interactions between a virtual assistant and the end user, one may perform several types of analysis. Knowing how to treat and interpret this data, as well as extracting the best possible indicators from the data facilitates the curation process, which involves continuous development of the virtual assistant, the identification of gaps in the virtual assistant's service and of subjects about which the virtual assistant is asked but is not able to answer.

A curation process can be performed by analyzing information such as whether the user has finished the service with the virtual assistant or abandoned the request, checking which are the most addressed issues, checking if the issues are being handled in the right way, and/or others. With these validations, one can establish strategies to improve the virtual assistant's training and work to enhance the virtual assistant's understanding with the end user.

Systems, methods and/or techniques disclosed herein provide a proactive curation process, identifying possible training confusions that exist within the virtual assistant without the need for the virtual assistant to be exposed to real conversations. Through the survey of errors that have been made during tests (such as confusion of which intent a certain example sentence really belongs to), the systems, method, and/or techniques build graphics that help the curator elucidate the fragility of the virtual assistant's current training.

The graphics allows the curator to understand the rules of the subject to be handled by the virtual assistant to align the technical knowledge with the decision making about the improvements to be applied. The graphics, which include graphs or visualizations of metrics, allow the curator to interpret and identify possible flaws and points of improvement in the way the virtual assistant handles the subjects.

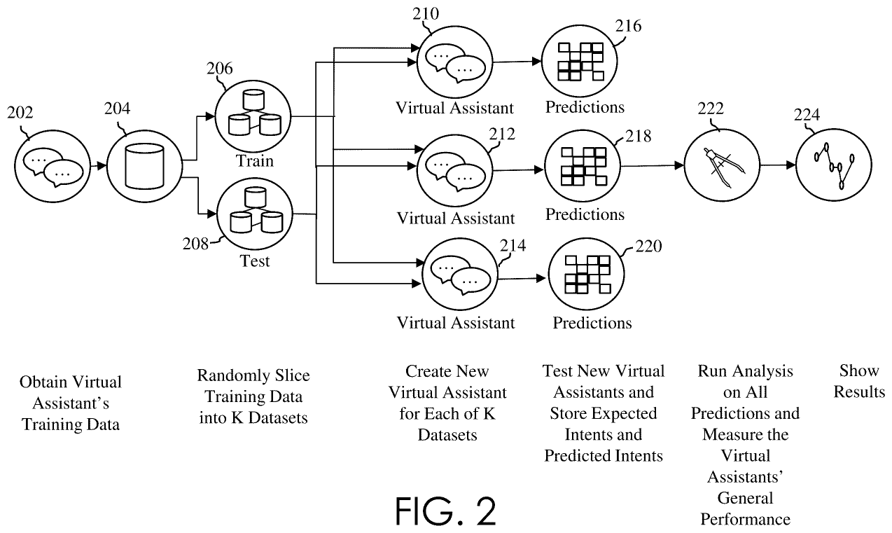

FIG. 2 is a diagram illustrating a process or method that evaluates how a trained virtual assistance performs in some embodiments. The process can be performed by or on one or more computer processors or hardware processors, for example, in a computer environment shown in FIG. 1 by way of example. In some embodiments, the process accesses a virtual assistant platform 202. The process includes obtaining data 204 on which the virtual assistant (referred to also as a given virtual assistant for explanation purposes only) is or was trained, for example, obtains the virtual assistant's training data. In some embodiments, the system, method and/or technique uses a process that includes cross validation (CV), a technique used to evaluate the performance of machine learning models. CV includes partitioning the data into sets (parts), where one set (e.g., referred to as training dataset 206) is used for training and another set (e.g., referred to as testing dataset 208) is used for testing, and evaluating the model's performance. Using CV has high chances of detecting whether the model is overfitting its training data, i.e., suffering from overfitting. In some embodiments, the process adopts a K-fold technique, where the process obtains the data 204 used to train the virtual assistant's intents, and separates this data 204 into k datasets, with k being configurable, for example, chosen based on the size and complexity of the database.

In some embodiments, from each of the k training datasets shown at 206, the process removes one or more samples. For example, the process randomly selects one or more samples and removes those one or more samples from each of the k training dataset.

For each of the k datasets, the process creates a virtual assistant (e.g., 210, 212, 214) with the training dataset 206 (i.e., trains a virtual assistant with at least one of the k datasets partitioned for training) and “talks” to it programmatically from the examples in the test dataset 208 (i.e., converse with the trained virtual assistant using the testing dataset), capturing the expected intent and predicted intent (e.g., predictions 216, 218, 220). An expected intent refers to a specific action or task the virtual assistant is programmed to perform based on user input (in this case samples from the testing dataset). A predicted intent refers to the virtual assistant's interpretation of the user's intent based on the virtual assistant's training data and the user's input.

For instance, the process creates and/or trains virtual assistant 210 with first one of the k datasets partitioned for training, removing one or more samples selected randomly from that first one of the k datasets partitioned for training before training the virtual assistant 210, and tests that virtual assistant 210 with first one of the k dataset partitioned for testing. Testing the virtual assistant 210 produces that virtual assistant's predictions 216.

Similarly, the process creates and/or trains virtual assistant 212 using second one of the k datasets partitioned for training, removing one or more samples selected randomly from that second one of the k datasets partitioned for training before training the virtual assistant 212, and tests that virtual assistant 212 with second one of the k dataset partitioned for testing. Testing the virtual assistant 212 produces that virtual assistant's predictions 218.

Likewise, the process creates and/or trains virtual assistant 214 using third one of the k datasets partitioned for training, removing one or more samples selected randomly from that third one of the k datasets partitioned for training before training the virtual assistant 214, and tests that virtual assistant 214 with third one of the k dataset partitioned for testing. Testing the virtual assistant 214 produces that virtual assistant's predictions 220. In this example scenario, k is chosen to be 3. Any other value of k can be configured.

While the above example, for simplicity of explanation, described k datasets partitioned for training and testing, where one of k datasets from training dataset and one of k datasets from testing dataset are used to create and/or train a new virtual assistant and test that new virtual assistant, the process may use any combinations of one or more k datasets from the training dataset and any combinations of one or more k datasets from the testing dataset to train a new virtual assistant. For instance, the process may train a virtual assistant (e.g., 210) using a different combination of k dataset than used to train another virtual assistant (e.g., 212 or 214).

For instance, the process may use a dataset that includes a combination of first and second of k datasets, remove one or more randomly selected samples from that combination of datasets and use that combination of datasets to train a virtual assistant 210. The process may use a dataset that includes a combination of second and third of k datasets, remove one or more randomly selected samples from that combination of datasets and use that combination of datasets to train a virtual assistant 212. The process may use a dataset that includes a combination of first and third of k datasets, remove one or more randomly selected samples from that combination of datasets and use that combination of datasets to train a virtual assistant 214. In some embodiments, for example, any combinations of k datasets partitioned as training dataset can be used for training a new virtual assistant, so long as each new virtual assistant is trained with different data (e.g., different combinations). Similarly, any one or more k datasets partitioned as test dataset can be used to test any one or more of the newly created or trained virtual assistants.

The system, method and/or technique analyze the results of those tests to generate metrics as shown at 222, which help the curator evaluate the virtual assistant's performance. Examples of the metrics that are generated include the following. Precision: this metric measures how many of the intent predictions made by the virtual assistant were correct, e.g., by comparing the expected intent with the predicted intent. Recall: this method measures how many of the intent class samples present in the dataset were correctly identified by the virtual assistant. F1: this metric combines precision and recall using their harmonic mean; Ideally, one would want to maximize both precision and recall metrics to obtain the perfect virtual assistant, thus maximizing the F1 score. Class distribution: this metric specifies how many examples or samples (e.g., phrases) an intent has (e.g., how many example phrases are in each subject); Class distribution metric is useful because too many examples may contribute to overfitting, while too small number of examples may contribute to underfitting. Precision at N: this metric measures the proportion of relevant items found in the top-n recommendations; This metric helps to measure the probability of the assistant recognizing the user intent on the first try, or to measure how good the virtual assistant's disambiguation is. Class accuracy: this metric measures precision, recall and f1 for each intent.

As shown at 224, as described above, the metrics can be presented as a visualization, e.g., graphs, scatter plots, charts and/or other graphical designs. In some embodiments, precision values of the new virtual assistants can be averaged or otherwise combined as provided as a prediction accuracy measure of the original virtual assistant. Precision metrics can be provided per intent or subject basis. Graphics or visualization showing metrics can include class distribution next to precision metric, providing a comprehensible view of how a number of examples can affect the virtual assistant's performance. As another example, a scatter plot may include points representing intents (e.g., subjects), where the y-axis shows precision measures associated with the respective intents. As yet further example, a table may show an expected intent next to a predicted intent. Other graphics or visualizations can be provided.

With the metrics, the curator is able to identify points for improvement in the training with greater accuracy and assertiveness. In addition, this analysis does not depend on actual conversations with the virtual assistant, which facilitates the cyclical process of training and curation even before the virtual assistant is deployed, e.g., to the public.

A process as described above with reference to FIG. 2 performs the following. Given a virtual assistant, e.g., shown at 202, the process obtains the virtual assistant's training data, e.g., shown at 204. As shown at 206 and 208 by way of example, the process randomly slices training data into k datasets, and splits each of k datasets into a training dataset and a test dataset, resulting in k training dataset and k test dataset. The process creates new virtual assistant for each of k datasets. For example, the process creates and/or trains k number of new virtual assistants (separate from the virtual assistant shown at 202), as shown at 210, 212, 214, using one or more of k training dataset, having random samples removed. The process tests new virtual assistants. For example, using one or more of k test dataset, the process tests each of the k new virtual assistants, where each of the k new virtual assistants produces predictions (e.g., predicted intents) as shown at 216, 218, 220. The process also stores expected intents and predicted intents. The process runs analysis on all predictions and measures the virtual assistants'general performance, for example, as shown at 222. The process shows results of the analysis, for example, graphically on a graphical user interface (GUI) as shown at 224.

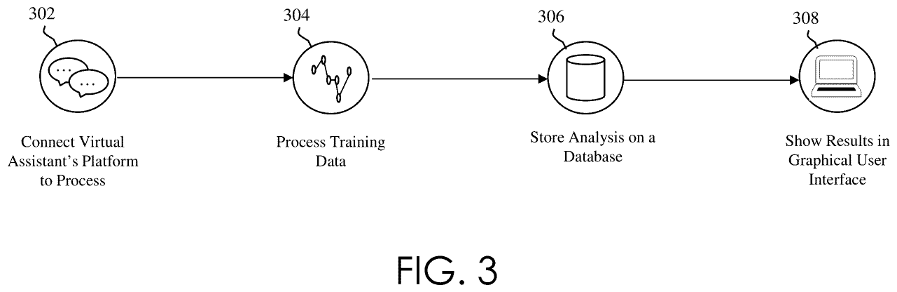

FIG. 3 shows components of a system in some embodiments. The virtual assistant's platform is connected to a process that performs the method shown in FIG. 2. For example, the process may be given permission or authorization to access the virtual assistant's platform. The virtual assistant's platform, e.g., includes a trained virtual assistant and the training data used for training the virtual assistant. The virtual assistant's platform may also include other data or information. Once connected at 302, the process obtains from the virtual assistant's platform, training data used to build or train the virtual assistant. The process then performs the method shown in FIG. 2, generating analysis results as shown at 304. The analysis results are stored on a database as shown at 306, to be presented on a graphical interface, e.g., to the curator. As shown at 308, the graphical interface shows the results in the form of graphics, which helps in better understanding the results and improving the training.

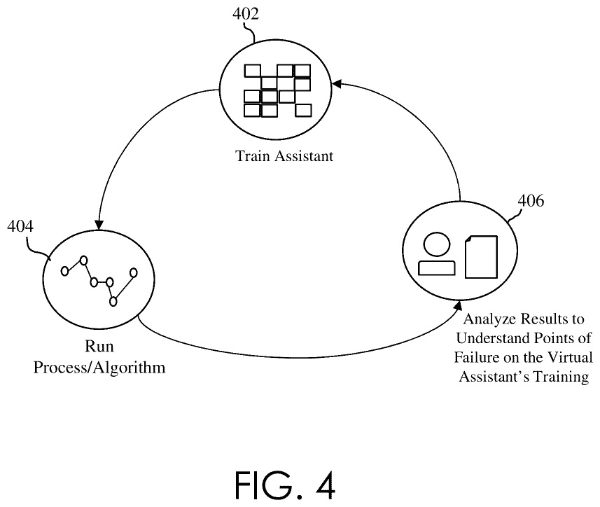

FIG. 4 shows an overall architecture of a development cycle for improving virtual assistant training in some embodiments. The virtual assistant is trained using training data at 402. At 404, the process or method described above (e.g., with reference to FIG. 2) is run. At 406, after analyzing the results, e.g., the curator is able to improve the virtual assistant's training. For example, the curator may supplement the training data with additional phrases directed to an intent, remove samples from the training data that may cause confusion in learning, and/or perform other actions. This cycle may continue until the virtual assistant's performance is satisfactory, and can be triggered again with any changes made to the virtual assistant. In some embodiments, a curator may be an automated tool. In some embodiments, a curator may be an administrator who can perform further improvements based on the graphical visualization.

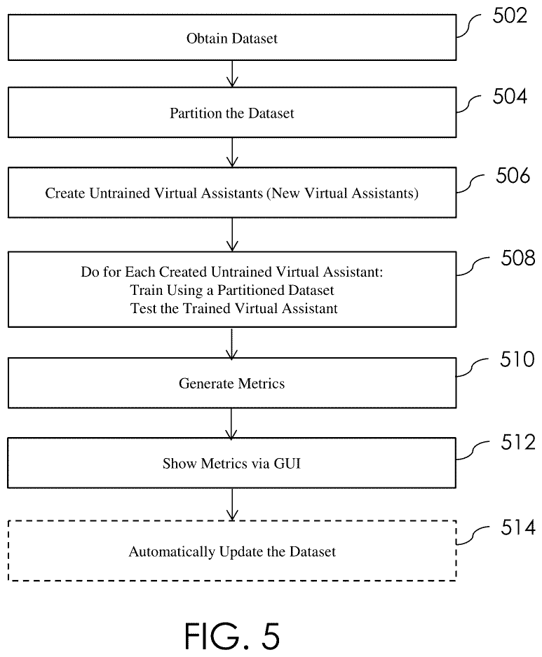

FIG. 5 is a flow diagram illustrating a method that improves virtual assistant training in some embodiments. The method can be performed on or by one or more computer processors or hardware processors, for example, operating in a computing environment by way of example shown in FIG. 1. As described above, an approach that improves training of virtual assistants can use cross validation, where the approach includes obtaining a dataset for training a virtual assistant. The approach can also include partitioning the dataset into a plurality of random datasets. The approach can also include creating a plurality of untrained virtual assistants equal to the number of the plurality of partitioned datasets. An untrained virtual assistant is also referred to above as a new virtual assistant. The approach can also include training each of the created untrained virtual assistant with one of the partitioned datasets, the one of the partitioned datasets having at least one of sample removed from the one of the partitioned datasets. The approach can also include testing each trained virtual assistant, capturing expected intent and predicted intent of the virtual assistant based on the dataset used to train the virtual assistant. The approach can also include generating a plurality of metrics for each of the virtual assistants, based on the testing, where the metrics can be one or more of precision, recall, F1, and/or others. The approach can also include determining one or more of the following scores to maximize the precision and recall metrics of the assistant, class distribution, precision at N, and class accuracy. The approach can also include displaying or presenting the test results, metrics, and scores to a user, via a graphical user interface.

Referring to FIG. 5, at 502, a processor performing the method obtains a dataset used for training a given virtual assistant. For instance, the given virtual assistant was previously trained using the dataset.

At 504, the processor partitions the dataset into a plurality of partitioned datasets. For instance, as described above with reference to FIG. 2, the dataset can be partitioned into k datasets, k being configurable. For example, k can be configured as a parameter in a program of instructions or operations programmed to perform the method.

At 506, the processor creates a plurality of untrained virtual assistants (also referred to as new virtual assistants) equal to a number of the plurality of partitioned datasets. For instance, as also described above with reference to FIG. 2, new virtual assistants are created (separate from the given virtual assistant).

At 508, for each created untrained virtual assistant of the created untrained virtual assistants, the processor trains the created untrained virtual assistant with at least one of the plurality of partitioned datasets having at least one random data sample removed at 508a, and tests the trained virtual assistant at 508b, capturing expected intent and predicted intent of the trained virtual assistant. For example, before the training of a new virtual assistant, the processor removes from a respective partitioned dataset to be used for training that new virtual assistant, one or more randomly selected samples. Removing samples randomly, rather than removing specific samples directed to known intents, avoids any bias in the results that are generated.

In some embodiments, for example, as described above, each of the plurality of partitioned datasets is split into a training dataset and test dataset, where at least one of the plurality of partitioned datasets used in the training is the split training dataset. In some embodiments, testing includes using the split test data in testing the trained virtual assistant.

In some embodiments, testing involves causing the trained virtual assistant to carry on a natural language conversation, e.g., with a test user, and/or using a programmed automated agent.

At 510, the processor generates a plurality of metrics for the trained virtual assistants based on the testing. As described above, examples of the plurality of metrics can include one or more of the following: a precision metric representing a number of correct predictions per intent generated by the trained virtual assistant; a recall metric representing a number of samples for an intent present in the at least one of the plurality of partitioned datasets used for training, which the trained virtual assistant correctly identified; a metric that combines the precision metric and the recall metric using a harmonic mean; a class distribution metric representing a number of samples per intent present in the at least one of the plurality of partitioned datasets used for training. Other metrics can be generated based on the results of testing the virtual assistants (new virtual assistants). In some embodiments, the precision associated with each trained virtual assistant is averaged and provided as a prediction accuracy of the given virtual assistant.

At 512, the processor presents via a graphical user interface results of the testing. For example, graphical visualizations associated with the results of the testing are presented via the graphical user interface.

In some embodiments, based on the testing and the generated metrics, at 514, the processor may automatically update the dataset used for training the given virtual assistant. For instance, the processor may employ a generative artificial intelligence model to generate additional sample data to add to the dataset. As another example, the processor may remove some sample data determined to be redundant or determined to contribute to overfitting, based on the generated metrics. Other updates can be automated made based on the testing and the generated metrics.

In some embodiments, the metrics provided graphically to a curator or user via a graphical user interface (GUI) allows the curator or the user to perform updates to the dataset used for training the given virtual assistant.

Once the updates to the dataset are satisfactory, e.g., the performance measure or metrics of the new virtual assistants converge to a minimum value (e.g., a configured or predefined threshold) through running the cycles of training (e.g., as shown in FIG. 4), the dataset can be used to retrain the given virtual assistant. Once retrained, the given virtual assistant can be deployed to the real world, for the given virtual assistant to carry on a natural language conversation with a real user in providing assistance to the real user. In some embodiments, the new virtual assistants created, trained and used in testing and generating the metrics can be removed or deleted.

The terminology used herein is for the purpose of describing particular embodiments only and is not intended to be limiting of the invention. As used herein, the singular forms “a”, “an” and “the” are intended to include the plural forms as well, unless the context clearly indicates otherwise. As used herein, the term “or” is an inclusive operator and can mean “and/or”, unless the context explicitly or clearly indicates otherwise. It will be further understood that the terms “comprise”, “comprises”, “comprising”, “include”, “includes”, “including”, and/or “having,” when used herein, can specify the presence of stated features, integers, steps, operations, elements, and/or components, but do not preclude the presence or addition of one or more other features, integers, steps, operations, elements, components, and/or groups thereof. As used herein, the phrase “in some embodiments” does not necessarily refer to the same embodiment, although it may. As used herein, the phrase “in one embodiment” does not necessarily refer to the same embodiment, although it may. As used herein, the phrase “in another embodiment” does not necessarily refer to a different embodiment, although it may. Further, embodiments and/or components of embodiments can be freely combined with each other unless they are mutually exclusive.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer-implemented method comprising:
obtaining a dataset used for training a given virtual assistant;
partitioning the dataset into a plurality of partitioned datasets;
creating a plurality of untrained virtual assistants equal to a number of the plurality of partitioned datasets;
for each created untrained virtual assistant of the created untrained virtual assistants,
training the created untrained virtual assistant with at least one of the plurality of partitioned datasets having at least one random data sample removed, and
testing the trained virtual assistant, capturing expected intent and predicted intent of the trained virtual assistant;
generating a plurality of metrics for the trained virtual assistants based on the testing; and
presenting via a graphical user interface results of the testing.

2. The method of claim 1, wherein each of the plurality of partitioned datasets is split into a training dataset and test dataset, wherein the at least one of the plurality of partitioned datasets used in the training is the split training dataset.

3. The method of claim 2, wherein the testing includes using the split test data in testing the trained virtual assistant.

4. The method of claim 1, wherein the presenting includes presenting visualizations associated with the results of the testing.

5. The method of claim 1, further including automatically updating the dataset used for training the given virtual assistant based on the plurality of metrics.

6. The method of claim 1, wherein the plurality of metrics includes at least a precision metric representing a number of correct predictions per intent generated by the trained virtual assistant.

7. The method of claim 6, wherein the precision associated with each trained virtual assistant is averaged and provided as prediction accuracy of the given virtual assistant.

8. The method of claim 6, wherein the plurality of metrics includes at least a recall metric representing a number of samples for an intent present in the at least one of the plurality of partitioned datasets used for training, which the trained virtual assistant correctly identified.

9. The method of claim 8, wherein the plurality of metrics includes at least a metric that combines the precision metric and the recall metric using a harmonic mean.

10. The method of claim 1, wherein the plurality of metrics includes at least a class distribution metric representing a number of samples per intent present in the at least one of the plurality of partitioned datasets used for training.

11. A computer program product comprising:
one or more computer-readable storage media; and
program instructions stored on the one or more storage media to perform operations comprising:
obtaining a dataset used for training a given virtual assistant;
partitioning the dataset into a plurality of partitioned datasets;
creating a plurality of untrained virtual assistants equal to a number of the plurality of partitioned datasets;
for each created untrained virtual assistant of the created untrained virtual assistants,
training the created untrained virtual assistant with at least one of the plurality of partitioned datasets having at least one random data sample removed, and
testing the trained virtual assistant, capturing expected intent and predicted intent of the trained virtual assistant;
generating a plurality of metrics for the trained virtual assistants based on the testing; and
presenting via a graphical user interface results of the testing.

12. The computer program product of claim 11, wherein each of the plurality of partitioned datasets is split into a training dataset and test dataset, wherein the at least one of the plurality of partitioned datasets used in the training is the split training dataset.

13. The computer program product of claim 12, wherein the testing includes using the split test data in testing the trained virtual assistant.

14. The computer program product of claim 11, wherein the presenting includes presenting visualizations associated with the results of the testing.

15. The computer program product of claim 11, wherein the operations further comprise automatically updating the dataset used for training the given virtual assistant based on the plurality of metrics.

16. A computer system comprising:
a processor set;
a set of one or more computer-readable storage media;
program instructions, collectively stored in the set of one or more computer-readable storage media, for causing the processor set to perform the following computer operations:
obtaining a dataset used for training a given virtual assistant;
partitioning the dataset into a plurality of partitioned datasets;
creating a plurality of untrained virtual assistants equal to a number of the plurality of partitioned datasets;
for each created untrained virtual assistant of the created untrained virtual assistants,
training the created untrained virtual assistant with at least one of the plurality of partitioned datasets having at least one random data sample removed, and
testing the trained virtual assistant, capturing expected intent and predicted intent of the trained virtual assistant;
generating a plurality of metrics for the trained virtual assistants based on the testing; and
presenting via a graphical user interface results of the testing.

17. The system of claim 16, wherein each of the plurality of partitioned datasets is split into a training dataset and test dataset, wherein the at least one of the plurality of partitioned datasets used in the training is the split training dataset.

18. The system of claim 17, wherein the testing includes using the split test data in testing the trained virtual assistant.

19. The system of claim 16, wherein the presenting includes presenting visualizations associated with the results of the testing.

20. The system of claim 16, wherein the operations further comprise automatically updating the dataset used for training the given virtual assistant based on the plurality of metrics.
